(19) United States
(12) Patent Application Publication
(10) Pub. No.: US 2012/0125749 A1
(43) Pub. Date: May 24, 2012

(54) COMPOSITE LIGHT-PERMITTING PANEL STRUCTURE

(75) Inventors: SHIH-CHIEH HSU, TAIPEI COUNTY (TW); YU-CHIEH LIN, TAIPEI HSIEN (TW); YOU-LIN CHEN, TAIPEI HSIEN (TW)

(73) Assignee: SILITECH TECHNOLOGY CORPORATION, TAIPEI HSIEN (TW)

(21) Appl. No.: 12/950,148

(22) Filed: Nov. 19, 2010

(51) Int. Cl. H01H 9/00

(52) U.S. Cl. 200/314

(57) ABSTRACT

A composite light-permitting panel structure includes a light-permitting substrate unit, a light-permitting printing unit and a light-permitting protruding unit. The light-permitting substrate unit includes at least one light-permitting body, and the light-permitting body has a top surface and a bottom surface. The light-permitting indicating unit includes a plurality of light-permitting printed indicators formed on the bottom surface of the light-permitting body. The light-permitting protruding unit includes a plurality of light-permitting protruding member members and at least one light-permitting frame member integrally formed on the top surface of the light-permitting body. The light-permitting protruding member members are selectively surrounded by the light-permitting frame. Thus, when the user touches and presses the top surface of the light-permitting body, the design of the light-permitting protruding members and/or the light-permitting frame can generate and provide 3D touch feeling for the user.

### BACKGROUND OF THE INVENTION

1. Field of the Invention

The instant disclosure relates to a composite light-permitting panel structure, and more particularly, to a composite light-permitting panel structure for providing three dimensional touch sensation.

2. Description of Related Art

With the development of technology, many diversified portable terminal apparatuses, such as personal digital assistants (PDAs), smart phones or PDA phones, are available in the market. These portable terminal apparatuses facilitate human life. In addition, the user interfaces of these portable terminal apparatuses are developed to allow the user to conduct an operation. For example, many portable terminal apparatuses have a key-type keyboard through which the user may conduct operations by pressing keys. In addition, a touch user interface may also be provided to facilitate the user's operation by way of touch.

In the related art, a portable terminal apparatus, such as a personal digital assistant, has one touch panel and one display screen. The touch panel and the display screen are disposed in the portable terminal apparatus, and the touch panel is disposed over the display screen. In addition, the touch panel is exposed from the portable terminal apparatus, thus the touch panel may be pressed. The portable terminal apparatus displays an operation frame through the display screen, and the operation frame has at least one object. For example, each key of a software keyboard on the operation frame is an object. These objects may be pressed/clicked and thus selected by the user. Although the user may control the portable terminal apparatus using his/her finger to press the touch panel, the user cannot easily use his/her finger to press/click the object when the object is smaller than a predetermined area. This is because that many objects may be pressed simultaneously or the object cannot be easily pressed correctly.

Furthermore, the related art also provides a touch panel with key function, and the top surface of the touch panel with key function is level. Hence, when a user touches and presses the top surface of the touch panel with key function, the touch panel with key function of the related art cannot provide 3D touch feeling for the user.

### SUMMARY OF THE INVENTION

One particular aspect of the instant disclosure is to provide a composite light-permitting panel structure for generating 3D touch feeling. When a user touches and presses the composite light-permitting panel structure of the instant disclosure, the instant disclosure can provides 3D touch feeling for the user.

To achieve the above-mentioned advantages, the instant disclosure provides a composite light-permitting panel structure, including: a light-permitting substrate unit, a light-permitting printing unit and a light-permitting protruding unit. The light-permitting substrate unit includes at least one light-permitting body, and the light-permitting body has a top surface and a bottom surface opposite to the top surface. The light-permitting printing unit includes a plurality of light-permitting printed indicators formed on the bottom surface of the light-permitting body. The light-permitting protruding unit includes a plurality of light-permitting protruding members integrally formed on the top surface of the light-permitting body.

To achieve the above-mentioned advantages, the instant disclosure provides a composite light-permitting panel structure, including: a light-permitting substrate unit, a light-permitting printing unit and a light-permitting protruding unit. The light-permitting substrate unit includes at least one light-permitting body, and the light-permitting body has a top surface and a bottom surface opposite to the top surface. The light-permitting printing unit includes a plurality of light-permitting printed indicators formed on the bottom surface of the light-permitting body. The light-permitting protruding unit includes at least one light-permitting frame integrally formed on the top surface of the light-permitting body.

To achieve the above-mentioned advantages, the instant disclosure provides a composite light-permitting panel structure, including: a light-permitting substrate unit, a light-permitting printing unit and a light-permitting protruding unit. The light-permitting substrate unit includes at least one light-permitting body, and the light-permitting body has a top surface and a bottom surface opposite to the top surface. The light-permitting printing unit includes a plurality of light-permitting printed indicators formed on the bottom surface of the light-permitting body. The light-permitting protruding unit includes a plurality of light-permitting protruding members and at least one light-permitting frame integrally formed on the top surface of the light-permitting body, and the light-permitting protruding members is selectively surrounded by the light-permitting frame.

Therefore, when the user touches and presses the top surface of the light-permitting body, the design of the light-permitting protruding members and/or the light-permitting frame can generate and provide 3D touch feeling for the user.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1A shows a perspective, schematic view of the composite light-permitting panel structure according to the first embodiment of the instant disclosure;

FIG. 1B shows a front, schematic view of the composite light-permitting panel structure according to the first embodiment of the instant disclosure;

FIG. 1C shows a top, schematic view of the composite light-permitting panel structure according to the first embodiment of the instant disclosure;

FIG. 2A shows a perspective, schematic view of the composite light-permitting panel structure according to the second embodiment of the instant disclosure; and

FIG. 2B shows a cross-sectional, schematic view taken along line A-A shown in FIG. 2A.

### DETAILED DESCRIPTION OF THE PREFERRED EMBODIMENTS

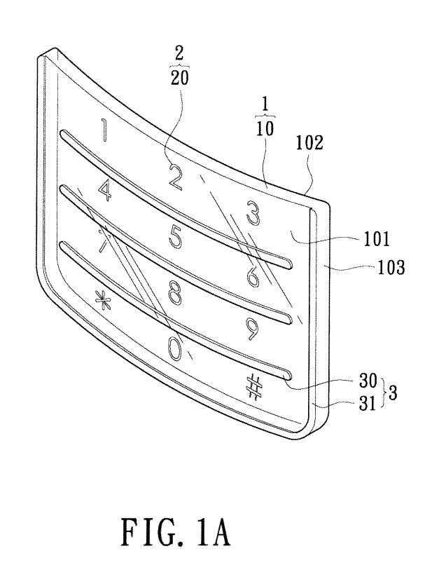

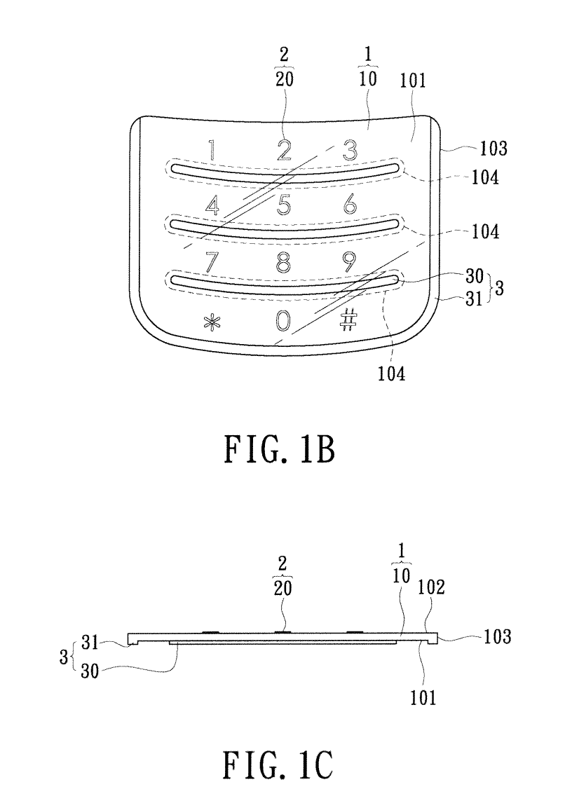

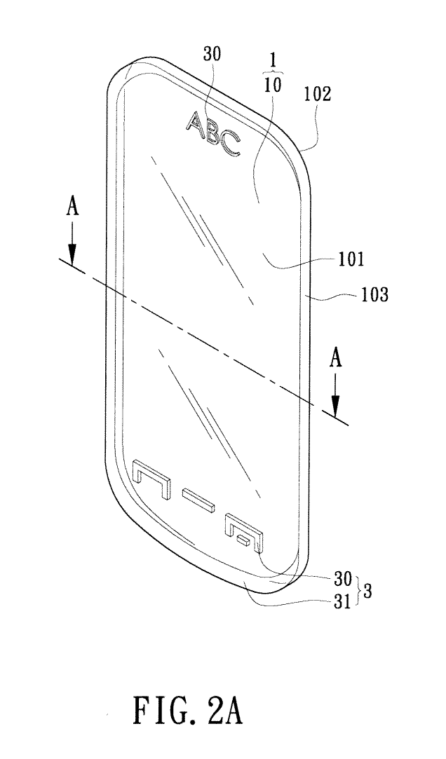

Referring to FIGS. 1A, 1B and 1C, in which a perspective schematic view, a front schematic view and a top schematic view of the first embodiment are shown, respectively. The first embodiment of the instant disclosure provides a composite light-permitting panel structure for increasing 3D touch feeling, including: a light-permitting substrate unit 1, a light-permitting printing unit 2 and a light-permitting protruding unit 3. The composite light-permitting panel structure of the instant disclosure can be applied to a touch key panel (it does not contain sensor under the touch key panel) of any electronic device, thus a user can press the touch key panel (it means the composite light-permitting panel structure) to drive the sensor to transmit commands to electronic device.

The light-permitting substrate unit 1 includes at least one light-permitting body 10, and the light-permitting body 10 has a top surface 101, a bottom surface 102 and an external peripheral surface 103. The external peripheral surface 103 is formed between the top surface 101 and the bottom surface 102 and surrounds the light-permitting body 10. The light-permitting body 10 can be made of glass material, silicone, epoxy or other light-permitting materials. For example, the light-permitting body 10 may be a light-permitting glass plate having a level top surface and a level bottom surface.

The light-permitting indicating unit 2 includes a plurality of light-permitting printed indicators 20 formed on the bottom surface 102 of the light-permitting body 10. For example, the light-permitting printed indicators 20 may be numbers, patterns, letters or other printing bodes formed on the bottom surface 102 of the light-permitting body 10 by printing, coating or other forming method. In addition, the light-permitting printed indicators 20 can be separated from each other by a predetermined distance and form a matrix having a plurality of rows and a plurality of columns. The light-permitting body 10 has a plurality of non-printing regions 104 on the bottom surface thereof, where each non-printing region 104 is formed between every two rows or columns. For example, referring to FIG. 1B, the arrangement of <1, 2, 3> is a first row, the arrangement of <4, 5, 6> is a second row, the arrangement of <7, 8, 9> is a third row and the arrangement of <*, 0, #> is a fourth row, thus a first non-printing region 104 is formed between the first and the second rows, a second non-printing region 104 is formed between the second and the third rows, a third non-printing region 104 is formed between the third and the fourth rows. Of course, each non-printing region 104 can be also formed between every two rows and every two columns according to different requirements.

The light-permitting protruding unit 3 includes a plurality of light-permitting protruding members 30 integrally formed on the top surface 101 of the light-permitting body 10. Each light-permitting protruding member 30 may be a light-permitting glass bar or a light-permitting resin bar, and each light-permitting protruding member 30 can correspond to each non-printing region 104. For example, in the first embodiment, there are three non-printing regions 104, thus there are three light-permitting protruding members 30 on the top surface 101 of the light-permitting body 10. Therefore, when the user touches and presses the top surface 101 of the light-permitting body 10, the design of the light-permitting protruding members 30 can generate 3D touching sensation for the user.

Furthermore, the light-permitting protruding unit 3 includes at least one light-permitting frame 31 integrally formed on the top surface 101 of the light-permitting body 10. The light-permitting frame 31 may be a light-permitting glass frame and a light-permitting resin frame, and the light-permitting protruding members 30 can be selectively surrounded by the light-permitting frame 31. For example, the light-permitting frame 31 may have a U-shaped appearance, thus one part of the light-permitting protruding members 30 can be surrounded by the U-shaped light-permitting frame 31. In addition, the light-permitting frame 31 is integrally formed on an outer surrounding region of the top surface 101 of the light-permitting body 10 to connect one part of the external peripheral surface 103. Therefore, when the user touches and presses the top surface 101 of the light-permitting body 10, the light-permitting frame 31 can generate 3D touch feeling for the user.

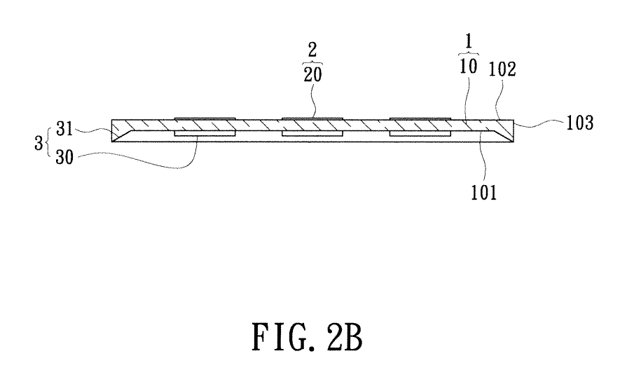

Referring to FIGS. 2A and 2B, in which a perspective schematic view of the second embodiment and a cross-sectional schematic view taken along line A-A in FIG. 2A are shown, respectively. The second embodiment of the instant disclosure provides a composite light-permitting panel structure for increasing 3D (three-dimensional) touch feeling, including: a light-permitting substrate unit 1, a light-permitting printing unit 2 and a light-permitting protruding unit 3.

The light-permitting substrate unit 1 includes at least one light-permitting body 10, and the light-permitting body 10 has a top surface 101, a bottom surface 102 opposite to the top surface 101 and an external peripheral surface 103. The external peripheral surface 103 is formed between the top surface 101 and the bottom surface 102 and surrounds the light-permitting body 10. For example, the light-permitting body 10 can be made of glass material, silicone, epoxy or other light-permitting material etc. The light-permitting body 10 may be a light-permitting glass plate having a sheet shape, and light-permitting glass plate has a level top surface and a level bottom surface.

The light-permitting printing unit 2 includes a plurality of light-permitting printed indicators 20 formed on the bottom surface 102 of the light-permitting body 10. For example, the light-permitting printed indicators 20 may be numbers, patterns, letters or other printing bodes formed on the bottom surface 102 of the light-permitting body 10 by printing, coating or other forming method.

The light-permitting protruding unit 3 includes a plurality of light-permitting protruding members 30 integrally formed on the top surface 101 of the light-permitting body 10. For example, each light-permitting protruding member 30 may be a light-permitting glass bar or a light-permitting resin bar, and each light-permitting protruding member 30 can selectively correspond to each light-permitting printing layer 20. Therefore, when the user touches and presses the top surface 101 of the light-permitting body 10, the design of the light-permitting protruding members 30 can generate 3D touch feeling for the user.

Furthermore, the light-permitting protruding unit 3 includes at least one light-permitting frame 31 integrally formed on the top surface 101 of the light-permitting body 10, where the light-permitting protruding members 30 can be selectively surrounded by the light-permitting frame 31, and the light-permitting frame 31 may be a light-permitting glass frame and a light-permitting resin frame. For example, the light-permitting frame 31 has a surrounding-shaped appearance, thus the whole light-permitting protruding members 30 can be surrounded by the light-permitting frame 31 with surrounding shape. In addition, the light-permitting frame 31 is integrally formed on an outer surrounding region of the top surface 101 of the light-permitting body 10 to connect the whole external peripheral surface 103. Therefore, when the user touches and presses the top surface 101 of the light-permitting body 10, the design of the light-permitting frame 31 can generate 3D touch feeling for the user.

In conclusion, when the user touches and presses the top surface of the light-permitting body, the design of the light-permitting protruding members and/or the light-permitting frame can generate and provide 3D touch feeling for the user.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A composite light-permitting panel structure, comprising:
a light-permitting substrate unit including at least one light-permitting body, wherein the at least one light-permitting body has a top surface and a bottom surface;
a light-permitting indicating unit including a plurality of light-permitting printed indicators formed on the bottom surface of the at least one light-permitting body; and
a light-permitting protruding unit including a plurality of light-permitting protruding members integrally formed on the top surface of the at least one light-permitting body.

2. The composite light-permitting panel structure of the claim 1, wherein the at least one light-permitting body is a light-permitting glass plate having a sheet shape.

3. The composite light-permitting panel structure of the claim 1, wherein the light-permitting printed indicators are separated from each other by a predetermined distance to form a matrix having a plurality of rows and a plurality of columns, wherein the at least one light-permitting body has a plurality of non-printing regions on the bottom surface thereof, each non-printing region is formed between every two rows or columns, and each light-permitting protruding member corresponds to each non-printing region.

4. The composite light-permitting panel structure of the claim 1, wherein the light-permitting printed indicators are separated from each other by a predetermined distance to form a matrix having a plurality of rows and a plurality of columns, wherein the at least one light-permitting body has a plurality of non-printing regions on the bottom surface thereof, each non-printing region is formed between every two rows and every two columns, and each light-permitting protruding member corresponds to each non-printing region.

5. The composite light-permitting panel structure of the claim 1, wherein each light-permitting protruding member is a light-permitting glass bar or a light-permitting resin bar.

6. The composite light-permitting panel structure of the claim 1, wherein each light-permitting protruding member selectively corresponds to each light-permitting printing layer.

7. The composite light-permitting panel structure of the claim 1, wherein the light-permitting protruding unit includes at least one light-permitting frame integrally formed on the top surface of the at least one light-permitting body, the light-permitting protruding members is selectively surrounded by the at least one light-permitting frame, and the at least one light-permitting frame is a light-permitting glass frame and a light-permitting resin frame.

8. A composite light-permitting panel structure, comprising:
a light-permitting substrate unit including at least one light-permitting body, wherein the at least one light-permitting body has a top surface and a bottom surface;
a light-permitting indicating unit including a plurality of light-permitting printed indicators formed on the bottom surface of the at least one light-permitting body; and
a light-permitting protruding unit including at least one light-permitting frame member integrally formed on the top surface of the at least one light-permitting body.

9. The composite light-permitting panel structure of the claim 8, wherein the at least one light-permitting body is a light-permitting glass plate having a sheet shape.

10. The composite light-permitting panel structure of the claim 8, wherein the at least one light-permitting frame is a light-permitting glass frame and a light-permitting resin frame.

11. The composite light-permitting panel structure of the claim 8, wherein the light-permitting protruding unit includes a plurality of light-permitting protruding members integrally formed on the top surface of the at least one light-permitting body, and the light-permitting protruding members is selectively surrounded by the at least one light-permitting frame.

12. The composite light-permitting panel structure of the claim 11, wherein the light-permitting printed indicators are separated from each other by a predetermined distance to form a matrix having a plurality of rows and a plurality of columns, wherein the at least one light-permitting body has a plurality of non-printing regions on the bottom surface thereof, each non-printing region is formed between every two rows or columns, and each light-permitting protruding member corresponds to each non-printing region.

13. The composite light-permitting panel structure of the claim 11, wherein the light-permitting printed indicators are separated from each other by a predetermined distance to form a matrix having a plurality of rows and a plurality of columns, wherein the at least one light-permitting body has a plurality of non-printing regions on the bottom surface thereof, each non-printing region is formed between every two rows and every two columns, and each light-permitting protruding member corresponds to each non-printing region.

14. The composite light-permitting panel structure of the claim 11, wherein each light-permitting protruding member is a light-permitting glass bar or a light-permitting resin bar.

15. The composite light-permitting panel structure of the claim 11, wherein each light-permitting protruding member selectively corresponds to each light-permitting printing layer.

16. A composite light-permitting panel structure, comprising:
a light-permitting substrate unit including at least one light-permitting body, wherein the at least one light-permitting body has a top surface and a bottom surface;
a light-permitting indicating unit including a plurality of light-permitting printed indicators formed on the bottom surface of the at least one light-permitting body; and
a light-permitting protruding unit including a plurality of light-permitting protruding member members and at least one light-permitting frame member integrally formed on the top surface of the at least one light-permitting body, the light-permitting protruding member members being selectively surrounded by the at least one light-permitting frame member.

17. The composite light-permitting panel structure of the claim 16, wherein the light-permitting printed indicators are separated from each other by a predetermined distance to form a matrix having a plurality of rows and a plurality of columns, wherein the at least one light-permitting body has a plurality of non-printing regions on the bottom surface thereof, each non-printing region is formed between every two rows or columns, and each light-permitting protruding member corresponds to each non-printing region.

18. The composite light-permitting panel structure of the claim 16, wherein the light-permitting printed indicators are separated from each other by a predetermined distance to form a matrix having a plurality of rows and a plurality of columns, wherein the at least one light-permitting body has a plurality of non-printing regions on the bottom surface thereof, each non-printing region is formed between every two rows and every two columns, and each light-permitting protruding member corresponds to each non-printing region.

19. The composite light-permitting panel structure of the claim 16, wherein each light-permitting protruding member selectively corresponds to each light-permitting printing layer.

20. The composite light-permitting panel structure of the claim 16, wherein the at least one light-permitting frame is a light-permitting glass frame and a light-permitting resin frame.
